(19) United States
(12) Patent Application Publication
(10) Pub. No.: US 2025/0219801 A1
(43) Pub. Date: Jul. 3, 2025

(54) DYNAMIC SUB-BAND OPERATION USING MULTI-ACCESS POINT COORDINATION

(71) Applicant: Cisco Technology, Inc., San Jose, CA (US)

(72) Inventors: Malcolm M. Smith, Richardson, TX (US); Matthew A. Silverman, Shaker Heights, OH (US); ALAN W. Dumdei, Greenville, TX (US); Indermeet S. Gandhi, San Jose, CA (US); Brian D. Hart, Sunnyvale, CA (US)

(73) Assignee: Cisco Technology, Inc., San Jose, CA (US)

(21) Appl. No.: 18/678,849

(22) Filed: May 30, 2024

Related U.S. Application Data
(60) Provisional application No. 63/615,857, filed on Dec. 29, 2023.

(51) Int. Cl. H04L 5/00; H04W 28/18; H04W 72/29

(52) U.S. Cl. CPC H04L 5/0094; H04W 28/18; H04W 72/29

(57) ABSTRACT

Coordinating Dynamic Sub-Band Operation (DSO) using Multi-Access Point (AP) Coordination (MAPC) may be provided. Coordinating DSO can include determining a proposed inter-Basic Service Set (BSS) DSO agreement for an Overlapping BSS (OBSS) and sending an inter-BSS DSO request to the OBSS based on the proposed inter-BSS DSO agreement. An inter-BSS DSO response is received from the OBSS. When the inter-BSS DSO response accepts the proposed inter-BSS DSO agreement, the proposed inter-BSS DSO agreement is established.

### RELATED APPLICATION

Under provisions of 35 U.S.C. § 119(e), Applicant claims the benefit of and priority to U.S. Provisional Application No. 63/615,857, filed Dec. 29, 2023, the disclosure of which is incorporated herein by reference in its entirety.

### TECHNICAL FIELD

The present disclosure relates generally to coordinating Dynamic Sub-band Operation using Multi-Access Point Coordination.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment;

FIG. 2 is a flow chart of a method for distributed coordination of DSO;

FIG. 3 is a flow chart of a method for centralized coordination of DSO; and

FIG. 4 is a block diagram of a computing device.

### DETAILED DESCRIPTION

### Overview

Coordinating Dynamic Sub-Band Operation (DSO) using Multi-Access Point (AP) Coordination (MAPC) may be provided. Coordinating DSO can include determining a proposed inter-Basic Service Set (BSS) DSO agreement for an Overlapping BSS (OBSS) and sending an inter-BSS DSO request to the OBSS based on the proposed inter-BSS DSO agreement. An inter-BSS DSO response is received from the OBSS. When the inter-BSS DSO response accepts the proposed inter-BSS DSO agreement, the proposed inter-BSS DSO agreement is established.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Dynamic sub-band operation (DSO) has been introduced to address the bottleneck that can form in a primary channel (e.g. a 20 MHz channel) with a high volume of traffic, particularly when there are Overlapping Basic Service Sets (OBSSs). OBSSs may exist when multiple Basic Service Sets (BSS) are within range of each other and operating on the same or overlapping channel. Thus, OBSSs may interfere with each other. Clients (e.g., non-Access Point (AP) Stations (STAs)) may operate with a smaller supported bandwidth than an AP supports, leading to overutilization of the primary channel and underutilization of other sub-channels that are not primary. DSO may enable other sub-channels of the operating bandwidth to be accessed without using or otherwise being blocked by the primary channel. For example, an AP can indicate to DSO-capable clients the sub-band (e.g., secondary channel) the client will use to communicate with the AP for one or more Transmit Opportunities (TxOps).

In single-AP scenarios (e.g., at a residence), the AP and clients can utilize DSO to help avoid blockages or interference by clients on the primary channel without interfering with other clients connected to another AP. However, in dense environments with multiple APs, such as an enterprise environment, DSO can lead to collisions on a sub-band between OBSSs as clients are instructed to communicate with an associated AP on various channels. For example, multiple APs in OBSSs may instruct clients to communicate on an overlapping primary channel or sub-band at the same time (e.g., one AP instructing a client to communicate on a secondary channel that is the primary channel of another AP in an OBSS, APs instructing clients to communicate on the same secondary channel at the same time, etc.), leading to interference. Thus, Multi-AP Coordination (MAPC) may be necessary for a network to implement DSO.

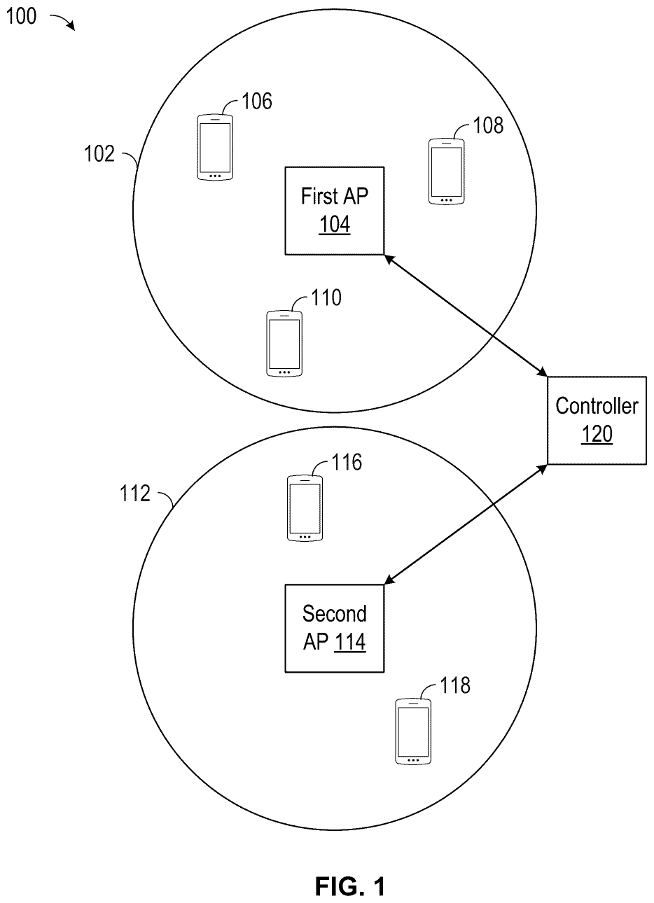

FIG. 1 is a block diagram of an operating environment 100. The operating environment 100 may include a first BSS 102 with a first AP 104, a first client 106, a second client 108, and a third client 110. The operating environment 100 may also include a second BSS 112 with a second AP 114, a fourth client 116, and a fifth client 118. The first BSS 102 and the second BSS 112 may be within range of each other and be operating on the same channel (e.g., the first AP 104 and the second AP 114 have the same primary channel or overlapping channel with different primary channels); therefore, the first BSS 102 and the second BSS 112 are OBSSs. The operating environment 100 may further include a controller 120.

The first AP 104 and the second AP 114 may enable clients to connect to the network. The first client 106, the second client 108, the third client 110, the fourth client 116, and the fifth client 118 may be any client device (e.g., a STA) that connects to the network to communicate with other devices on the network, such as a smart phone, a tablet, a personal computer, a server, and/or the like. The controller 120 may be any network controller (e.g., a Wireless Local Area Network (WLAN) controller) and may manage the first AP 104, the second AP 114, and/or other network devices to allow wireless devices such as the first client 106, the second client 108, the third client 110, the fourth client 116, and the fifth client 118 to connect to the network. The operating environment 100 is an example configuration and there may be a different number of BSSs, clients, APs, controllers, and/or other devices in further examples. For example, more than two OBSSs may coordinate for DSO.

The first AP 104 and the second AP 114 may coordinate for DSO (e.g., to determine non-primary channel access for the first BSS 102 and the second BSS 112). In some embodiments, the first AP 104 and the second AP 114 may perform distributed coordination, coordinating DSO between the first AP 104 and the second AP 114 without the controller 120. The first AP 104 and the second AP 114 may coordinate using an inter-BSS DSO agreement. Because the first BSS 102 and the second BSS 112 may have multiple respective OBSSs, the first BSS 102 and/or the second BSS 112 may have multiple inter-BSS DSO agreements active at a time.

To initiate establishment of an inter-BSS DSO agreement, a BSS can send an inter-BSS DSO request to establish rules of the DSO agreement when the BSS detects a full or partial OBSS. For example, the first AP 104 may detect that the second BSS 112 is an OBSS and send an inter-BSS DSO request to the second AP 114. The inter-BSS DSO request may be a management action frame, and the inter-BSS DSO request may include the BSS Media Access Control (MAC) address of the BSS sending the request as the source (e.g., the BSS MAC address of the first BSS 102 when the first AP 104 sends the inter-BSS DSO request to the second AP 114), the BSS MAC address of the BSS receiving the request as the destination (e.g., the BSS MAC address of the second BSS 112 when the first AP 104 sends the inter-BSS DSO request to the second AP 114), the BSS ID of the BSS sending the request, the BSS ID of the BSS receiving the request, proposed rules of the inter-BSS DSO agreement, a duration of the agreement, sub-band options, a sub-band selection, and/or the like.

The proposed rules of DSO may detail how the APs in the inter-BSS DSO agreement should operate. The duration of the agreement can be indefinite (e.g., until one of the BSSs requests to dissolve the agreement), for a static period, for one or more beacon periods, for one or more Target Wait Time (TWT) periods, for defined shared periods (e.g., one or more periods the requesting BSS can use a sub-band and one or more periods the receiving BSS can use the sub-band), and/or the like. Additionally, the duration of the agreement can indicate that the inter-BSS DSO agreement will alternate being active and inactive (e.g., active during a period estimated to have high traffic and inactive during a period estimated to have low traffic). The sub-band options may be one or more sub-bands the receiving BSS (e.g., the second AP 114) can select or assign priorities to for selecting a sub-band when utilizing DSO. The sub-band selection may be one or more sub-bands the sending AP (e.g., the first AP 104) selects or assigns priorities to for selecting a sub-band when utilizing DSO. For example, the first AP 104 may select a single sub-band to request for DSO. The sub-band may be 20 MHz, 40 MHz, or 80 MHz. In another embodiment, the requesting BSS may select priorities for secondary sub-bands, in which the requesting BSS would first use the highest priority sub-band for DSO, then the second highest priority sub-band, and so on.

In response to the request, the receiving BSS may send an inter-BSS DSO response. The inter-BSS DSO response may be a management action frame that includes an indication of whether the receiving BSS accepts or rejects the inter-BSS DSO request, a rejection reason code if the receiving BSS rejects (e.g., conflict with sub-band selection, disagree with proposed period, disagree with requesting BSS sub-band priorities, none, etc.), the sub-band selection (e.g., from the sub-band options), and/or the like. For example, the second AP 114 may accept select a sub-band that the first AP 104 did not select as indicated by the sub-band selection. In some embodiments, the second AP 114 selects priorities for the sub-bands, and the priorities may be determined based on the priorities the first AP 104 selects as indicated by the sub-band selection. For example, the second AP 114 may select priorities to distinguish from the first AP 104 priorities, so the first AP 104 and the second AP 114 do not select the same sub-band or otherwise reduce the number of times the first AP 104 and the second AP 114 select the same sub-band. For example, if the same sub-band has the highest priority for both the first AP 104 and the second AP 114, the first AP 104 and the second AP 114 may instruct clients to communicate on the same sub-band. Thus, the receiving AP may select sub-band priorities based on the requesting AP sub-band priorities to avoid potential interference.

In other embodiments, the inter-BSS DSO request may request the receiving BSS to not use a sub-band for a duration. For example, if a BSS agrees to the request, the BSS may not use the indicated sub-band, relinquishing use of the sub-band to the requesting BSS for the duration of the agreement period. In other examples, the sub-band may be shared, and the requesting BSS may use the sub-band for one or more period and the receiving BSS may use the sub-band for one or more other periods.

To dissolve the inter-BSS DSO agreement, the first BSS 102 and the second BSS 112 may exchange an inter-BSS DSO dissolution request. For example, the first AP 104 may send the inter-BSS DSO dissolution request to the second AP 114 to dissolve the inter-BSS DSO agreement. The inter-BSS DSO dissolution request be a management action frame, and the inter-BSS DSO dissolution request may include a dissolution reason code (e.g., conflict with another OBSS, none, etc.), a time to end the inter-BSS DSO agreement, and/or the like. The receiving BSS may respond with an inter-BSS DSO dissolution response to acknowledge the inter-BSS DSO dissolution request.

In some embodiments, the inter-BSS DSO agreement is established by the APs of OBSSs directly communicating to establish the agreement. For example, the first AP 104 and the second AP 114 may directly exchange the inter-BSS DSO request, the inter-BSS DSO response, the inter-BSS DSO dissolution request, and/or the inter-BSS DSO dissolution response. In other embodiments, the first AP 104 and the second AP 114 may not be in range to communicate directly but clients of the other BSS are in range. For example, the fourth client 116 may be in range of the first AP 104 and/or the third client 110 may be in range of the second AP 114. Therefore, the first AP 104 and the second AP 114 may communicate the inter-BSS DSO request, the inter-BSS DSO response, the inter-BSS DSO dissolution request, and/or the inter-BSS DSO dissolution response via the third client 110 and/or the fourth client 116. In further embodiments, the inter-BSS DSO request, the inter-BSS DSO response, the inter-BSS DSO dissolution request, and/or the inter-BSS DSO dissolution response can be exchanged between the first AP 104 and the second AP 114 via a relay, such as an Over-the-Air (OTA) relay. In some embodiments, the inter-BSS DSO request, the inter-BSS DSO response, the inter-BSS DSO dissolution request, and/or the inter-BSS DSO dissolution response can be exchanged wire once an OBSS is detected via clients.

Once an inter-BSS DSO agreement is established, the first AP 104, the second AP 114, and/or the controller 120 may reject any request, such as a Subchannel Selective Transmission (SST) request, from the first client 106, the second client 108, the third client 110, the fourth client 116, and/or the fifth client 118 that conflicts with any DSO Agreement. For example, allowing an SST request enables a client to select and switch channels between transmissions. Thus, an SST request can only be allowed if the client sending the request will be limited to switching between the primary channel and any sub-channel the BSS associated with the client is allocated according to any active inter-BSS DOS agreements. Additionally, any potentially conflicting operation, such as an Enhanced Multilink Single-Radio Operation (EMLSR)-type control of DSO at an AP (i.e., dynamic switching between the primary channel and/or sub-bands) is authorized, rejected, and/or performed based on any established inter-BSS DSO agreement (e.g., based on any agreed to sub-band access and any agreed to sharing schedule). The first AP 104 and the second AP 114 can provide the first client 106, the second client 108, the third client 110, the fourth client 116, and/or the fifth client 118 information via an information element in a beacon so the clients can determine which channels are available and therefore avoid sending a SST request that will be rejected.

In some embodiments, the controller 120 may control inter-BSS DSO agreements. Therefore, the first AP 104 and the second AP 114 may not need to perform the distributed coordination described above to establish an inter-BSS DSO agreement in these embodiments. The controller 120 may be aware of all APs (i.e., the first AP 104 and the second AP 114), their primary channel, their other channels, neighbor OBSSs (e.g., the first BSS 102 and the second BSS 112 are OBSSs), clients, and/or the like, and the controller 120 may create Coordination Groups (CGs) and assign AP leaders for the CGs. The controller 120 may semi-statically assign APs to CGs.

In certain embodiments, the controller 120 may semi-statically assign a secondary channel for DSO to APs (e.g., the first AP 104 and the second AP 114). To determine the assignment, the controller 120 may retrieve the Received Signal Strength Indicator (RSSI) from OBSS APs (e.g., the RSSI of the signal the first AP 104 receives from the second AP 114 and the RSSI of the signal the second AP 114 receives from the first AP 104), primary channel information, and/or the like. The controller 120 may then use the RSSIs from OBSS APs, the primary channel information, and the like to determine secondary channel assignments for the inter-BSS DSO agreement or some other DSO coordination and inform the APs of the assigned secondary channels semi-statically in the order of a beacon period. The controller 120 may also reevaluate the assignments to make changes on a semi-static basis. For example, the controller 120 may reevaluate the assignments and update the assignments in the order of a beacon period. The controller 120 can also limit an AP and its clients to any bandwidth (e.g., limiting the bandwidth to less than the bandwidth of one of the AP's radios).

In some examples, the controller 120 may determine there is not an assignment for the APs to perform DSO. Thus, the controller 120 may disable DSO functionality altogether. The controller 120 may reevaluate possible assignments periodically to restore DSO functionality.

In some embodiments, the controller 120 can have more than one AP operate on a secondary channel and specify how the APs will share the secondary channel. For example, the controller 120 can indicate the sharing method, such as Coordinated Spatial Reuse (C-SR), Coordinated Frequency-Division Multiple Access (C-FDMA), Coordinated Orthogonal Frequency-Division Multiple Access (C-OFDMA), Coordinated Time-Division Multiple Access (C-TDMA), and/or the like and provide required information for the APs to share the secondary channel. In a coordinated TxOp, the controller 120 can send to a CG leader the secondary channel assignment for each AP in the CG.

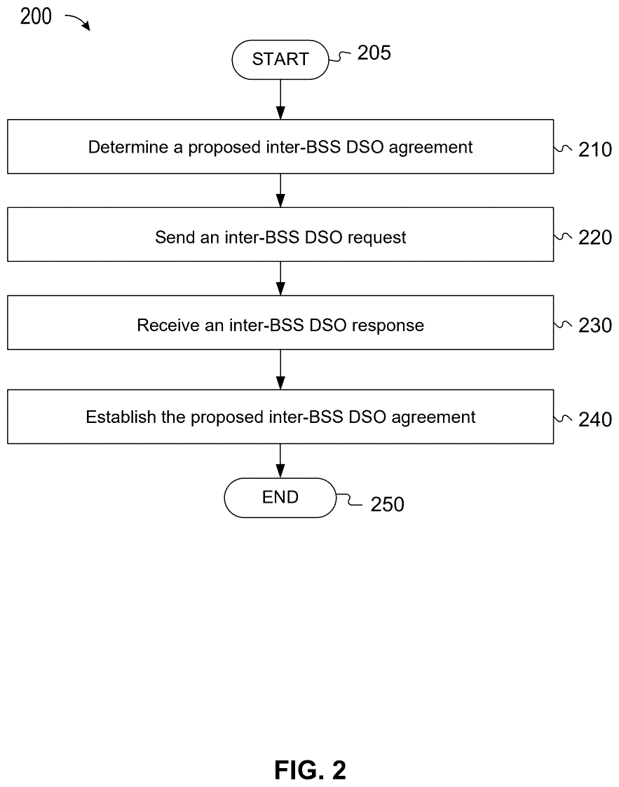

FIG. 2 is a flow chart of a method 200 for distributed coordination of DSO. The method 200 may begin at starting block 205 and proceed to operation 210. In operation 210, a proposed inter-BSS DSO agreement is determined for an OBSS. For example, the first AP 104 determines a proposed inter-BSS DSO agreement for the second BSS 112. The proposed inter-BSS DSO agreement may include an agreement duration, sub-band options, a sub-band selection, and/or the like as described above. The first AP 104 may determine the proposed inter-BSS DSO agreement in response to detecting the second BSS 112 is an OBSS.

In operation 220, an inter-BSS DSO request is sent to the OBSS. For example, the first AP 104 sends the inter-BSS DSO request to the second AP 114. The inter-BSS DSO request may be a management action frame based on the proposed inter-BSS DSO agreement. For example, the inter-BSS DSO request can include a duration of the agreement, sub-band options, a sub-band selection, and/or the like. In some examples, the first AP 104 and the second AP 114 may not be able to directly communicate, so the first AP 104 can send the inter-BSS DSO request via a relay or wire.

In operation 230, an inter-BSS DSO response is received from the OBSS. For example, the first AP 104 receives the inter-BSS DSO response from the second AP 114. The inter-BSS DSO response may indicate whether the second AP 114 accepts or rejects the proposed inter-BSS DSO agreement and may include a reason code for the rejection if the second AP 114 rejects the agreement. In some examples, the first AP 104 and the second AP 114 may not be able to directly communicate, so the second AP 114 can send the inter-BSS DSO response via a relay or wire.

In operation 240, when the inter-BSS DSO response accepts the proposed inter-BSS DSO agreement, the proposed inter-BSS DSO agreement is established. For example, the first AP 104 may begin operating according to the proposed inter-BSS DSO agreement when the inter-BSS DSO response accepts the proposed inter-BSS DSO agreement. The second AP 114 is aware the agreement is accepted when sending the inter-BSS DSO response, so the second AP 114 may begin operating according to the proposed inter-BSS DSO agreement after sending the response.

When the inter-BSS DSO response rejects the proposed inter-BSS DSO agreement, the proposed inter-BSS DSO agreement may be modified, and a modified inter-BSS DSO request may be sent based on the modified proposed inter-BSS DSO agreement. For example, the first AP 104 may modify the proposed inter-BSS DSO agreement and send a modified inter-BSS DSO request to the second AP 114. The first AP 104 may modify the proposed inter-BSS DSO agreement based at least in part on the reason code included in the inter-BSS DSO response.

In some examples, one of the BSSs may determine to dissolve the inter-BSS DSO agreement and send an inter-BSS DSO dissolution request. The inter-BSS DSO dissolution request can include a reason code for dissolving the inter-BSS DSO dissolution agreement. In some examples, the controller 120 may control the sub-bands available to the first BSS 102 and the second BSS 112. The first AP 104 and the second AP 114 may send a RSSI associated with the OBSS and channel information to the controller 120. The controller 120 may determine secondary channel assignments for the first BSS 102 and the second BSS 112 based on the RSSIs and channel information. The first AP 104 and the second AP 114 may then receive the secondary channel assignments from the controller 120. The method 200 may conclude at ending block 250.

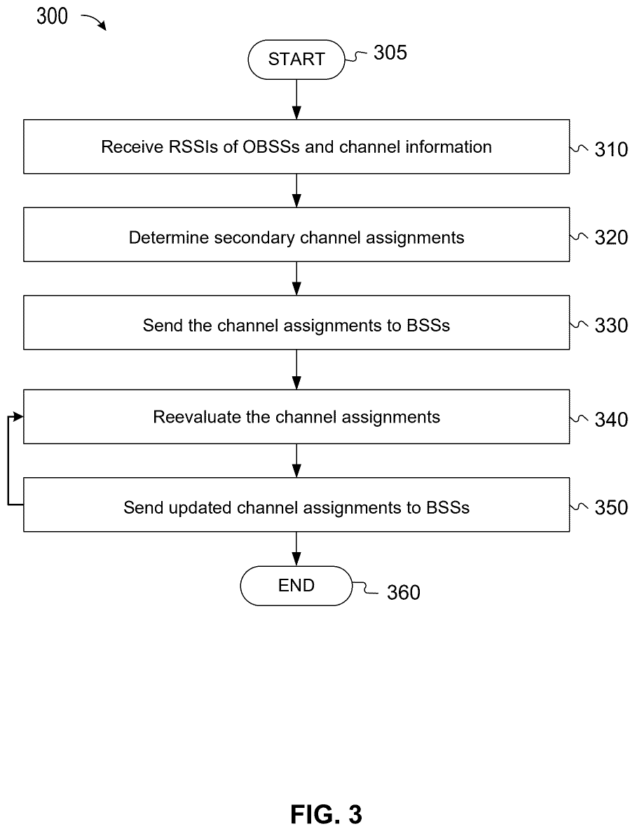

FIG. 3 is a flow chart of a method 300 for centralized coordination of DSO. The method 300 may begin at starting block 305 and proceed to operation 310. In operation 310, RSSIs of OBSSs and channel information is received. For example, the controller 120 receives the RSSIs of the OBSSs from the first AP 104 (e.g., the RSSI of the signal received from the second AP 114) and the second AP 114 (e.g., the RSSI of the signal received from the first AP 104) and channel information from the first AP 104 and the second AP 114.

In operation 320, secondary channel assignments are determined. For example, the controller 120 determines secondary channel assignments for the first AP 104 and the second AP 114 based on the RSSIs of the OBSSs and the channel information. In some examples, the controller 120 may determine no channel assignments are feasible and disable DSO and indicate that no secondary channels are assigned. The controller 120 may periodically reevaluate the RSSIs of the OBSSs, channel information, and/or the like to determine secondary channel assignments. In some examples, multiple APs may use the same secondary channel, and the controller 120 may indicate a method for sharing the secondary channel.

In operation 330, the channel assignments are sent to the BSSs. For example, the controller 120 sends the secondary channel assignments to the first AP 104 and the second AP 114. The controller 120 may send the channel assignments semi-statically, such as in the order of a beacon period. The controller 120 can also limit the bandwidth of the first AP 104, the second AP 114, the first client 106, the second client 108, the third client 110, the fourth client 116, and/or the fifth client 118.

In operation 340, the channel assignments are reevaluated. For example, the controller 120 may periodically reevaluate the channel assignments to determine if new channels should be assigned to one or more APs. If the controller 120 determines new channel assignments, the controller 120 can send the updated channel assignments to BSSs (e.g., the first BSS 102 via the first AP 104 and the second BSS 112 via the second AP 114) in operation 350. The method 300 may conclude at ending block 360.

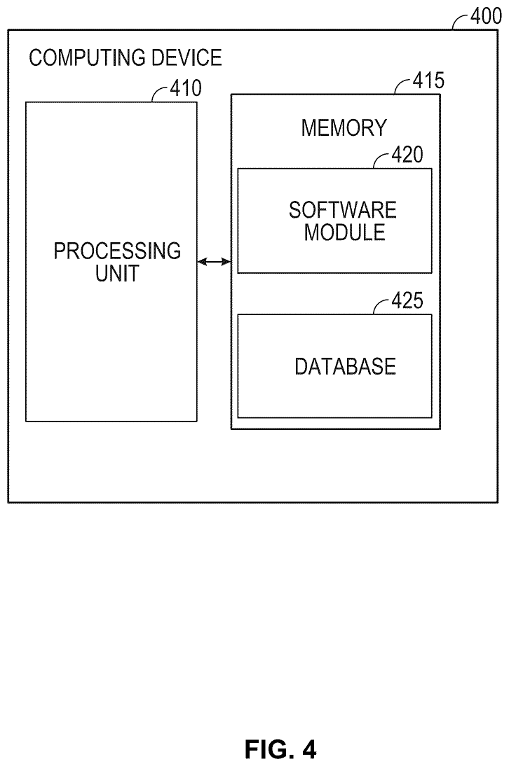

FIG. 4 is a block diagram of a computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for coordinating DSO using MAPC with respect to FIG. 1, FIG. 2, and FIG. 3. Computing device 400, for example, may provide an operating environment for the first AP 104, the first client 106, the second client 108, the third client 110, the second AP 114, the fourth client 116, the fifth client 118, the controller 120, and the like. The first AP 104, the first client 106, the second client 108, the third client 110, the second AP 114, the fourth client 116, the fifth client 118, the controller 120, and the like may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining a proposed inter-Basic Service Set (BSS) Distributed Sub-band Operation (DSO) agreement for an Overlapping BSS (OBSS);
sending an inter-BSS DSO request to the OBSS based on the proposed inter-BSS DSO agreement;
receiving an inter-BSS DSO response from the OBSS; and
when the inter-BSS DSO response accepts the proposed inter-BSS DSO agreement, establishing the proposed inter-BSS DSO agreement.

2. The method of claim 1, wherein determining the proposed inter-BSS DSO agreement is in response to detecting the OBSS.

3. The method of claim 1, further comprising, when the inter-BSS DSO response rejects the proposed inter-BSS DSO agreement:
modifying the proposed inter-BSS DSO agreement; and
sending a modified inter-BSS DSO request based on the modified proposed inter-BSS DSO agreement.

4. The method of claim 3, wherein:
the inter-BSS DSO response comprises a reason code for the rejection; and
modifying the proposed inter-BSS DSO agreement is based at least in part on the reason code.

5. The method of claim 1, wherein the inter-BSS DSO request comprises any one of (i) a duration of the proposed inter-BSS DSO agreement, (ii) sub-band options, (iii) a sub-band selection, or (iv) any combination of (i)-(iii).

6. The method of claim 1, further comprising:
determining to dissolve the proposed inter-BSS DSO agreement; and
sending an inter-BSS DSO dissolution request.

7. The method of claim 1, wherein sending the inter-BSS DSO request and receiving the inter-BSS DSO response is via any one of (i) a relay, or (ii) wire.

8. The method of claim 1, further comprising:
sending a Received Signal Strength Indicator (RSSI) associated with the OBSS and channel information to a controller; and
receiving a secondary channel assignment from the controller.

9. A system comprising:
a memory storage; and
a processing unit coupled to the memory storage, wherein the processing unit is operative to:
determine a proposed inter-Basic Service Set (BSS) Distributed Sub-band Operation (DSO) agreement for an Overlapping BSS (OBSS);
send an inter-BSS DSO request to the OBSS based on the proposed inter-BSS DSO agreement;
receive an inter-BSS DSO response from the OBSS; and
when the inter-BSS DSO response accepts the proposed inter-BSS DSO agreement, establish the proposed inter-BSS DSO agreement.

10. The system of claim 9, wherein to determine the proposed inter-BSS DSO agreement is in response to detecting the OBSS.

11. The system of claim 9, wherein the processing unit is further operative to, when the inter-BSS DSO response rejects the proposed inter-BSS DSO agreement:
modify the proposed inter-BSS DSO agreement; and
send a modified inter-BSS DSO request based on the modified proposed inter-BSS DSO agreement.

12. The system of claim 9, wherein the inter-BSS DSO request comprises any one of (i) a duration of the proposed inter-BSS DSO agreement, (ii) sub-band options, (iii) a sub-band selection, or (iv) any combination of (i)-(iii).

13. The system of claim 9, wherein the processing unit is further operative to:
determine to dissolve the proposed inter-BSS DSO agreement; and
send an inter-BSS DSO dissolution request.

14. The system of claim 9, wherein to send the inter-BSS DSO request and receive the inter-BSS DSO response is via any one of (i) a relay, or (ii) wire.

15. The system of claim 9, wherein the processing unit is further operative to:
send a Received Signal Strength Indicator (RSSI) associated with the OBSS and channel information to a controller; and
receive a secondary channel assignment from the controller.

16. A non-transitory computer-readable medium that stores a set of instructions which when executed perform a method executed by the set of instructions comprising:
determining a proposed inter-Basic Service Set (BSS) Distributed Sub-band Operation (DSO) agreement for an Overlapping BSS (OBSS);
sending an inter-BSS DSO request to the OBSS based on the proposed inter-BSS DSO agreement;
receiving an inter-BSS DSO response from the OBSS; and
when the inter-BSS DSO response accepts the proposed inter-BSS DSO agreement, establishing the proposed inter-BSS DSO agreement.

17. The non-transitory computer-readable medium of claim 16, wherein determining the proposed inter-BSS DSO agreement is in response to detecting the OBSS.

18. The non-transitory computer-readable medium of claim 16, the method executed by the set of instructions further comprising, when the inter-BSS DSO response rejects the proposed inter-BSS DSO agreement:
modifying the proposed inter-BSS DSO agreement; and
sending a modified inter-BSS DSO request based on the modified proposed inter-BSS DSO agreement.

19. The non-transitory computer-readable medium of claim 16, wherein the inter-BSS DSO request comprises any one of (i) a duration of the proposed inter-BSS DSO agreement, (ii) sub-band options, (iii) a sub-band selection, or (iv) any combination of (i)-(iii).

20. The non-transitory computer-readable medium of claim 16,
receiving an inter-BSS DSO dissolution request from the OBSS;
stopping the proposed inter-BSS DSO agreement; and
sending an inter-BSS DSO dissolution response to the OBSS.
